(19) United States
(12) Patent Application Publication
(10) Pub. No.: US 2025/0385283 A1
(43) Pub. Date: Dec. 18, 2025

(54) ENERGY GENERATION DEVICE

(71) Applicants: HYUNDAI MOTOR COMPANY, Seoul (KR); KIA CORPORATION, Seoul (KR)

(72) Inventors: Hyun Bae Dong, Hwaseong-si (KR); Ju Hae Jung, Hwaseong-si (KR)

(73) Assignees: HYUNDAI MOTOR COMPANY, Seoul (KR); KIA CORPORATION, Seoul (KR)

(21) Appl. No.: 18/927,170

(22) Filed: Oct. 25, 2024

(30) Foreign Application Priority Data
Jun. 18, 2024 (KR) 10-2024-0079139

(51) Int. Cl. H01M 8/04089; H01M 8/04082; H01M 8/0444; H01M 8/04746; H01M 8/0662

(52) U.S. Cl. CPC H01M 8/04097; H01M 8/04201; H01M 8/04447; H01M 8/04761; H01M 8/0662

(57) ABSTRACT

An energy generation device may include a first fuel cell pack including a plurality of fuel cell modules configured to use hydrogen as fuel, a storage part configured to store exhaust gas discharged from the first fuel cell pack and containing hydrogen, and a resupply line configured to supply the exhaust gas from the storage part to the first fuel cell pack or an external fuel cell pack.

### CROSS-REFERENCE TO RELATED APPLICATION

This application claims priority to and the benefit of Korean Patent Application No. 10-2024-0079139, filed in the Korean Intellectual Property Office on Jun. 18, 2024, the entire contents of which are incorporated herein by reference.

### TECHNICAL FIELD

The present disclosure relates to an energy generation device using a hydrogen fuel cell.

### BACKGROUND ART

A hydrogen fuel cell refers to a power generation device that produces water and electrical energy by means of a reaction between oxygen in the air and hydrogen extracted from fuel such as petroleum or gas. Because the hydrogen fuel cell generates electrical energy by using a redox reaction instead of a power generation method using a turbine in the related art, the hydrogen fuel cell is advantageous in that high energy efficiency is implemented, and a small amount of contaminants is produced during a power generation process.

A fuel cell for power generation may include a plurality of fuel cell power generation modules in a power generation system. Unlike fuel cells used in a vehicle, which need to release hydrogen while operating, this system can capture and reuse hydrogen without emitting hydrogen into the atmosphere.

In case that hydrogen contained in discharged gas is reused immediately or purified and then reused, there may be an advantage in terms of efficiency in using hydrogen.

The above-mentioned background art is technical information that the inventors have retained to derive the present disclosure or have obtained in the course of deriving the present disclosure, and cannot be thus said to be technical information publicly known to the public before filing the present application.

### SUMMARY

The present disclosure has been made in an effort to solve the above-mentioned problem, and an object of the present disclosure is to improve energy generation efficiency of an energy generation device using a hydrogen fuel cell module.

An embodiment of the present disclosure provides an energy generation device including: a first fuel cell pack including a plurality of fuel cell modules configured to use hydrogen as fuel; a storage part configured to store exhaust gas that is discharged from the first fuel cell pack and contains hydrogen; and a resupply line connected to the storage part and configured to supply the exhaust gas, which is stored in the storage part, to the first fuel cell pack or an external fuel cell pack.

Each of the plurality of fuel cell modules provided in the first fuel cell pack may operate in a first mode in which hydrogen recirculates from a hydrogen electrode outlet of a fuel cell toward a hydrogen electrode inlet of the fuel cell.

The energy generation device may further include a supply line configured to supply outside hydrogen to the first fuel cell pack. The resupply line communicates with the supply line.

The energy generation device may further include: a purification part provided in the resupply line and configured to receive the exhaust gas from the storage part and purify the hydrogen contained in the exhaust gas.

The energy generation device may further include: a second fuel cell pack including a plurality of fuel cell modules and provided outside the first fuel cell pack. The resupply line connects the second fuel cell pack and the storage part and is configured to supply the exhaust gas to the second fuel cell pack.

The first fuel cell pack may be provided as a plurality of first fuel cell packs.

Each of the plurality of fuel cell modules provided in the second fuel cell pack may operate in a second mode to discharges hydrogen from a fuel cell without recirculating hydrogen.

The energy generation device may further include: a purification part provided in the resupply line and configured to receive the exhaust gas from the storage part and purify hydrogen contained in the exhaust gas. Each of the plurality of fuel cell modules provided in the second fuel cell pack operates in a first mode in which hydrogen recirculates from a hydrogen electrode outlet of a fuel cell toward a hydrogen electrode inlet of the fuel cell.

The first fuel cell pack may include: a first fuel cell group including a plurality of fuel cell modules that operates in a first mode in which hydrogen recirculates from a hydrogen electrode outlet of a fuel cell toward a hydrogen electrode inlet of the fuel cell; and a second fuel cell group including a plurality of fuel cell modules that operates in a second mode in which hydrogen is discharged from the fuel cell without recirculating hydrogen.

The storage part may store exhaust gas discharged from the first fuel cell group, and the resupply line may be connected to the second fuel cell group from the storage part and configured to supply the exhaust gas, which is stored in the storage part, to the second fuel cell group.

The amount of hydrogen per time supplied to the first fuel cell group may be larger than the amount of hydrogen per time supplied to the second fuel cell group.

The energy generation device may further include: a hydrogen concentration acquisition unit connected to the resupply line and configured to sense a hydrogen concentration of exhaust gas flowing from the storage part toward the second fuel cell pack.

The energy generation device may further include: a flow rate control unit coupled to the resupply line between the hydrogen concentration acquisition unit and the second fuel cell pack and configured to control a flow rate of the exhaust gas.

The energy generation device according to the embodiment of the present disclosure may improve the energy generation efficiency by recirculating hydrogen.

In addition, the technical effects may include effects readily predictable by those having ordinary skill in the art from the configurations according to the embodiment of the present disclosure.

### BRIEF DESCRIPTION OF THE DRAWINGS

FIG. 1 is a structural view of an energy generation device according to a first embodiment of the present disclosure.

FIG. 2 is a view illustrating a flow of gas in a first fuel cell pack of the energy generation device illustrated in FIG. 1.

FIG. 3 is a view illustrating an operating method of a fuel cell module that operates in a first mode.

FIG. 4 is a structural view of an energy generation device according to a second embodiment of the present disclosure.

FIG. 5 is a structural view of an energy generation device according to a third embodiment of the present disclosure.

FIG. 6 is a view illustrating an operating method of a fuel cell module that operates in a second mode.

FIG. 7 is a structural view of an energy generation device according to a fourth embodiment of the present disclosure.

FIG. 8 is a structural view of an energy generation device according to a fifth embodiment of the present disclosure.

FIG. 9 is a structural view of an energy generation device according to a sixth embodiment of the present disclosure.

### DETAILED DESCRIPTION

Hereinafter, embodiments of the present disclosure are described in detail with reference to the accompanying drawings so that those with ordinary skill in the art to which the present disclosure pertains may easily carry out the embodiments. The following description is one of several aspects of the embodiments. In the description of the present disclosure, a specific description of a function or configuration already publicly known has been omitted in order to clarify the subject matter of the present disclosure.

In assigning reference numerals to constituent elements of the respective drawings in the present specification, the same or similar constituent elements will be designated by the same or similar reference numerals throughout the specification. The constituent element, which has the same common function as the constituent element included in any one embodiment, is described by using the same name in other embodiments. Terms or words used in the specification and the claims should not be interpreted as being limited to a general or dictionary meaning and should be interpreted as a meaning and a concept which conform to the technical spirit of the present disclosure based on a principle that an inventor can appropriately define a concept of a term in order to describe his/her own invention by the best method.

When a component, device, element, or the like of the present disclosure is described as having a purpose or performing an operation, function, or the like, the component, device, or element should be considered herein as being “configured to” meet that purpose or to perform that operation or function.

In addition, the present disclosure is not limited to the embodiments and may be variously modified and altered from the disclosure by those having ordinary skill in the art to which the present disclosure pertains. Accordingly, the spirit of the present disclosure should not be limited to the described embodiment, and all of the equivalents or equivalent modifications of the claims as well as the appended claims belong to the scope of the spirit of the present disclosure.

### First Embodiment

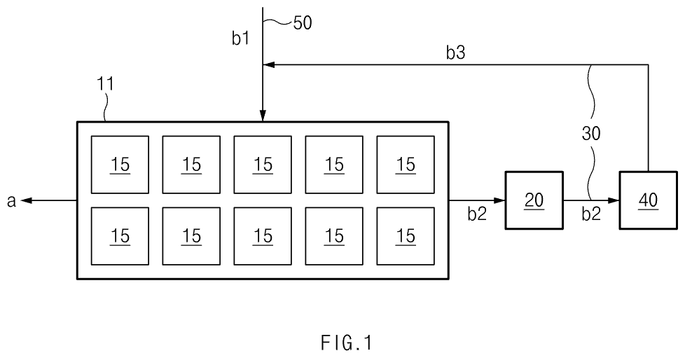

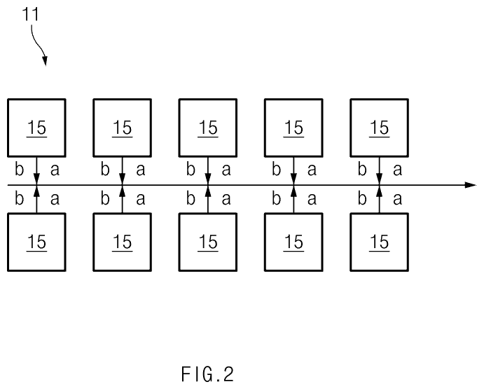

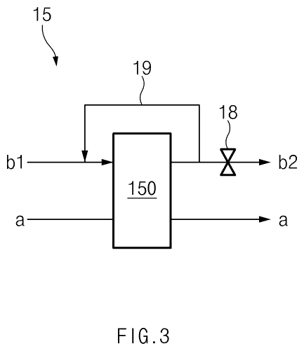

FIG. 1 is a schematic structural view of an energy generation device according to a first embodiment of the present disclosure. FIG. 2 illustrates a flow of gas in a first fuel cell pack 11 in FIG. 1. FIG. 3 is a view illustrating an operating configuration of each fuel cell module 15 that operates in a first mode in the first fuel cell pack 11.

With reference to FIGS. 1 to 3, the energy generation device according to the first embodiment of the present disclosure may include the first fuel cell pack 11, a storage part 20, and a resupply line 30. The energy generation device according to the first embodiment of the present disclosure may further include a supply line 50.

The first fuel cell pack 11 may be equipped with a plurality of fuel cell modules 15. The plurality of fuel cell modules 15 may each use hydrogen as fuel. The fuel cell modules 15 may each be configured to generate electrical energy by means of a reaction between hydrogen and oxygen in the air. The fuel cell module 15 may include at least one fuel cell having constituent elements such as electrodes, electrolytes, and separators. For example, the fuel cell module 15 may be a fuel cell stack in which a plurality of fuel cells are stacked on one another. Hydrogen gas and air may be supplied to each of the fuel cell modules 15. After electrical energy is generated by the reaction between hydrogen and oxygen in the air, water may be produced as a by-product in the fuel cell module 15.

The first fuel cell pack 11 broadly refers to one unit body having the plurality of fuel cell modules therein and separated from another fuel cell pack by a physical frame, such as a housing, for example. The structure of the first fuel cell pack 11 may also be equally applied to a second fuel cell pack to be described below. In other words, the fuel cell pack may be an assembly of the fuel cell modules, and the assembly may accommodate the plurality of fuel cell modules. In other words, the fuel cell pack may be a unit body for supplying hydrogen and air. For example, the plurality of fuel cell modules 15 in the first fuel cell pack 11 may be operated by hydrogen and air supplied to the first fuel cell pack 11.

After the reaction, each of the plurality of fuel cell modules 15 in the first fuel cell pack 11 may discharge exhaust gas (“b”) and air (“a”) that contain hydrogen, and the exhaust gas (b) and the air (a) may flow through a preset flow path in the first fuel cell pack 11 (see FIG. 2). The hydrogen gas and air, which are exhaust gases after being used, may be discharged to the outside of the fuel cell module 15.

A supply gas “b1”, which contains high-purity hydrogen, may be supplied to the first fuel cell pack 11 through the supply line 50. The supply line 50 may be configured to supply outside hydrogen to the first fuel cell pack 11. For example, the supply line 50 may include a flow channel, such as a supply pipe, in which hydrogen may flow. The high-purity hydrogen, which is contained in the supply gas b1 supplied to the first fuel cell pack 11, may be supplied to each of the plurality of fuel cell modules 15 in the first fuel cell pack 11 and used to generate electrical energy. Thereafter, exhaust gas “b2” containing hydrogen with relatively low purity may be discharged to the outside of the first fuel cell pack 11. The air (a) may be discharged to the outside of the first fuel cell pack 11 through a route provided separately from a route for hydrogen.

The storage part 20 may be configured to store the exhaust gas b2. The storage part 20 may be provided in the flow path for the exhaust gas b2. For example, the storage part 20 may be provided in the form of a gas chamber having a preset capacity. For example, the storage part 20 may be equipped with a separate member, such as a valve, configured to control the inflow and outflow of the exhaust gas b2.

The exhaust gas b2 stored in the storage part 20 may be in a state in which the exhaust gas b2 contains hydrogen having relatively lower purity than hydrogen contained in the supply gas b1. The hydrogen contained in the exhaust gas b2 stored in the storage part 20 may be resupplied to the first fuel cell pack 11 through the resupply line 30.

The resupply line 30 may be configured to supply the exhaust gas b2, which is stored in the storage part 20, to the first fuel cell pack 11 or an external fuel cell pack. In the first embodiment of the present disclosure, the resupply line 30 may be configured to resupply the exhaust gas b2 in the storage part 20 to the first fuel cell pack 11. In this case, the resupply line 30 may communicate with the supply line 50. The resupply line 30 may connect the storage part 20 and the supply line 50. The resupply line 30 may transmit hydrogen in the exhaust gas b2, which is stored in the storage part 20, to the supply line 50. Like the supply line 50, the resupply line 30 may have a flow path in which gas flows. The resupply line 30 may include a power unit (not illustrated), such as a blower, that generates a flow of the exhaust gas b2.

The energy generation device according to the first embodiment of the present disclosure may further include a purification part 40. The purification part 40 may be provided in the resupply line 30. In other words, the purification part 40 may be disposed in the resupply line 30 between the storage part 20 and the supply line 50, receive the exhaust gas b2 from the storage part 20, and purify hydrogen contained in the exhaust gas b2. The purification part 40 may purify hydrogen contained in the exhaust gas b2 in the resupply route of the resupply line 30, thereby converting the exhaust gas b2 containing low-purity hydrogen into a purified gas b3 containing hydrogen with relatively high purity. The purified gas b3 produced by the purification part 40 may be supplied to the supply line 50. For example, the purified gas b3 may have the same degree of hydrogen concentration as the supply gas b1 in the supply line 50.

In the energy generation device according to the first embodiment of the present disclosure, each of the plurality of fuel cell modules provided in the first fuel cell pack 11 may be the fuel cell module 15 that operates in a first mode (see FIG. 3). In the case of the fuel cell module 15 that operates in the first mode, hydrogen may recirculate from a hydrogen electrode outlet of a fuel cell 150 toward a hydrogen electrode inlet of the fuel cell 150. In this case, hydrogen recirculates at least once. In case that the hydrogen concentration of the discharged gas decreases to a preset numerical value or less or a preset time elapses after the recirculation, the exhaust gas b2 may be discharged. For example, the fuel cell module 15 according to the first mode may be a dead-end type fuel cell module that generates power in a state in which an outlet of an anode and an outlet of a cathode are closed.

Specifically, in the fuel cell module 15 according to the first mode, a recirculation loop 19 may be provided in a hydrogen supply line, such that the hydrogen concentration of the initially inputted supply gas b1 may pass through the fuel cell 150 multiple times while repeatedly recirculating, and the hydrogen content may gradually decrease. In case that the hydrogen concentration of the supply gas b1 subjected to the recirculation process decreases to a reference numerical value or less, a purge valve 18 may be opened, and the gas, which is in the form of the exhaust gas b2, may be discharged to the outside of the module. In contrast, the supply gas b1 subjected to the recirculation process may be discharged to the outside in the form of the exhaust gas b2 in case that a reference time elapses. The supply line for the air (a) may be provided separately from the flow paths for the exhaust gas b2 and the supply gas b1 that contain hydrogen.

With the application of the purification part 40 and the resupply line 30, the first fuel cell pack 11 including the fuel cell modules 15 may reduce, in the first mode, the amount of supply gas b1 containing high-concentration hydrogen required to be supplied through the supply line 50, which may significantly improve the power generation efficiency of the energy generation device.

### Second Embodiment

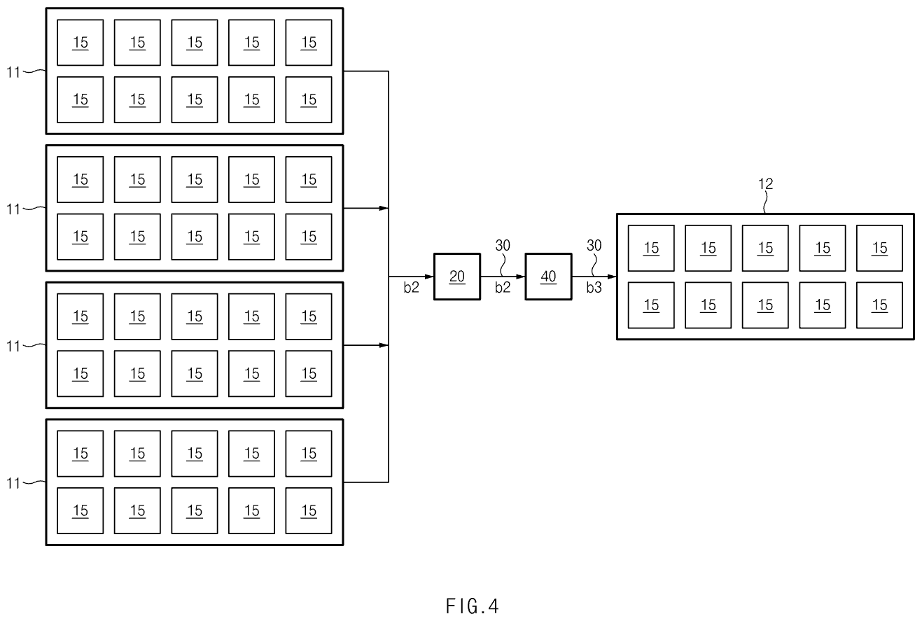

FIG. 4 is a structural view of an energy generation device according to a second embodiment of the present disclosure.

The second embodiment of the present disclosure may differ from the first embodiment in that the exhaust gas b2 from the first fuel cell pack 11 is supplied to an external second fuel cell pack 12 instead of recirculating to the first fuel cell pack 11. It is noted that the description of the energy generation device according to the first embodiment of the present disclosure may also be applied in common to the second embodiment, except for the difference. Therefore, the description of the contents described in the first embodiment is omitted, if possible, and the second embodiment is described, focusing on the difference from the first embodiment.

With reference to FIG. 4, the energy generation device according to the second embodiment of the present disclosure may further include the external second fuel cell pack 12 provided separately from the first fuel cell pack 11. The second fuel cell pack 12 may be equipped with the plurality of fuel cell modules 15. Each of the plurality of fuel cell modules 15 provided in the second fuel cell pack 12 may be the fuel cell module that operates in the first mode. The fuel cell module 15 provided in the first fuel cell pack 11 may also be the fuel cell module that operates in the first mode.

The exhaust gas b2, which is discharged from the first fuel cell pack 11 and contains hydrogen with a relatively low concentration, may flow so as to be supplied to the second fuel cell pack 12. In this case, the first fuel cell pack 11 may be provided as a plurality of first fuel cell packs 11. The number of first fuel cell packs 11 may be greater than the number of second fuel cell packs 12. For example, as illustrated, four first fuel cell packs 11 may be provided for one second fuel cell pack 12 to supply the exhaust gas b2. However, the present disclosure is not limited thereto.

The storage part 20 may be configured to store the exhaust gas b2 from the plurality of first fuel cell packs 11. The resupply line 30 may be provided outside the first fuel cell pack 11 and configured to supply the exhaust gas b2 to the second fuel cell pack 12 from the plurality of first fuel cell packs 11. The resupply line 30 may connect the second fuel cell pack 12 and the storage part 20, which stores the exhaust gas b2 discharged from the plurality of first fuel cell packs 11. The resupply line 30 is configured to supply the exhaust gas b2, which is stored in the storage part 20, to the second fuel cell pack 12.

The energy generation device according to the second embodiment of the present disclosure may further include the purification part 40. The purification part 40 may purify hydrogen contained in the exhaust gas b2, thereby converting the exhaust gas b2 containing low-purity hydrogen into the purified gas b3 containing hydrogen with relatively high purity. The purified gas b3 produced by the purification part 40 may be supplied to the second fuel cell pack 12.

### Third Embodiment

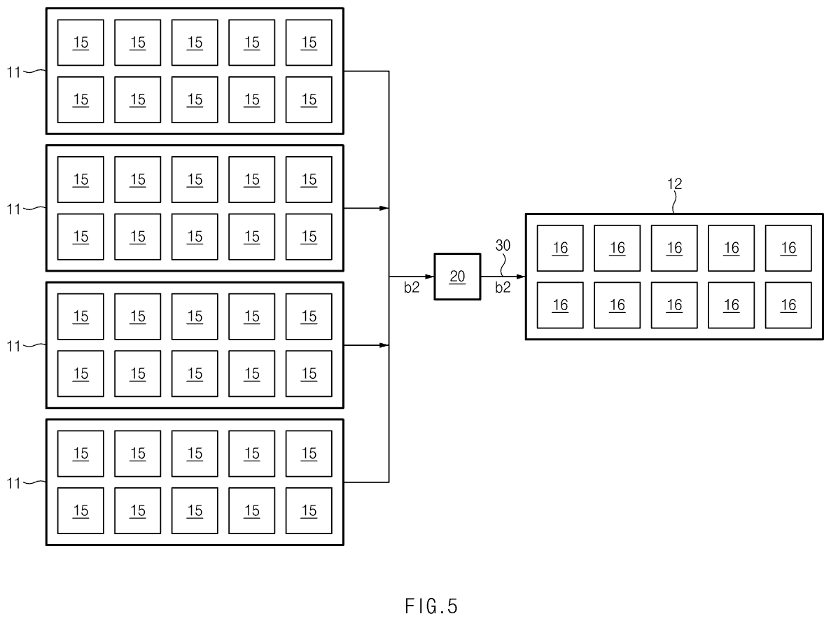

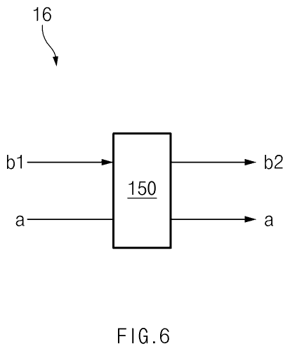

FIGS. 5 to 6 illustrate an energy generation device according to a third embodiment of the present disclosure. FIG. 5 is a structural view of the energy generation device according to the third embodiment of the present disclosure, and FIG. 6 is a view illustrating an operating method of a fuel cell module that operates in a second mode.

The third embodiment of the present disclosure may differ from the second embodiment in that each of the plurality of fuel cell modules provided in the second fuel cell pack 12 is a fuel cell module 16 that operates in the second mode. Likewise, it is noted that the description of the energy generation device according to the embodiments of the present disclosure may also be applied in common to the third embodiment, except for the difference. Therefore, the description of the contents described in the previous embodiments is omitted, if possible, and the third embodiment is described, focusing on the difference from the second embodiment.

With reference to FIG. 5, the exhaust gas b2 from the plurality of first fuel cell packs 11 may be stored in the storage part 20. The fuel cell module 15 provided in the first fuel cell pack 11 may be the fuel cell module that operates in the first mode. The exhaust gas b2 stored in the storage part 20 may be supplied to the second fuel cell pack 12 through the resupply line 30.

The second fuel cell pack 12 may be equipped with the plurality of fuel cell modules 16. Each of the fuel cell modules 16 provided in the second fuel cell pack 12 may be the fuel cell module that operates in the second mode.

With reference to FIG. 6, the fuel cell module 16 configured to operate in the second mode may be a fuel cell module that operates without recirculating hydrogen. In other words, the fuel cell module 16 may, in the second mode, discharge hydrogen from the fuel cell 150 without recirculating hydrogen. The supply gas b1 may be discharged as the exhaust gas b2 after the reaction in the fuel cell 150. The supply line for the air (a) may be provided separately from the flow paths for the exhaust gas b2 and the supply gas b1 that contain hydrogen. In case that the fuel cell module 16 of the second fuel cell pack 12 operates in the second mode, a separate process of purifying hydrogen may not be required.

With the application of the above-mentioned configuration, in the energy generation device according to the third embodiment of the present disclosure, the exhaust gas b2 stored in the storage part 20 may be supplied to the second fuel cell pack 12 without a separate purification process, which may improve the process performance.

### Fourth Embodiment

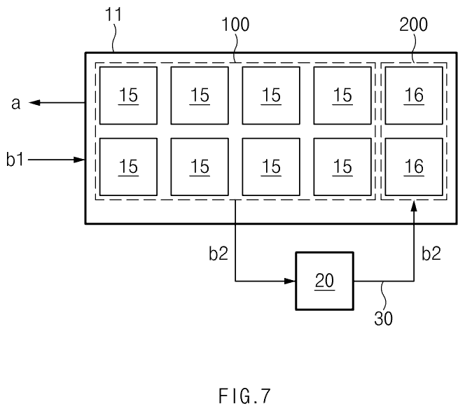

FIG. 7 is a structural view of an energy generation device according to a fourth embodiment of the present disclosure.

The fourth embodiment of the present disclosure may differ from the previous embodiments in that the plurality of fuel cell modules provided in the first fuel cell pack 11 includes both the fuel cell module 15 configured to operate in the first mode and the fuel cell module 16 configured to operate in the second mode, and the recirculation of hydrogen is performed in the first fuel cell pack 11. Likewise, it is noted that the description of the energy generation device according to the embodiments of the present disclosure may also be applied in common to the fourth embodiment, except for the difference. Therefore, the description of the contents described in the previous embodiments is omitted, if possible, and the description is focused on the features of the fourth embodiment.

With reference to FIG. 7, the energy generation device according to the fourth embodiment of the present disclosure may include the first fuel cell pack 11, the storage part 20, and the resupply line 30.

The first fuel cell pack 11 may be equipped with the plurality of fuel cell modules 15 and 16. The plurality of fuel cell modules 15 and 16 may be divided into a first fuel cell group 100 and a second fuel cell group 200. In other words, the first fuel cell pack 11 may include the first fuel cell group 100 and the second fuel cell group 200.

The first fuel cell group 100 may include the plurality of fuel cell modules 15 configured to operate in the first mode in which hydrogen is recirculated and the exhaust gas is discharged when the hydrogen concentration of the discharged gas decreases to a preset numerical value or less, or when a preset time elapses. The second fuel cell group 200 may include the plurality of fuel cell modules 16 configured to operate in the second mode in which hydrogen is discharged without recirculating. The number of fuel cell modules 15 of the first fuel cell group 100 may be greater than the number of fuel cell modules 16 of the second fuel cell group 200.

High-purity hydrogen b1 may be supplied from the outside, and the storage part 20 may be configured to store the exhaust gas b2 discharged from the fuel cell module 15 of the first fuel cell group 100. The exhaust gas b2, which is stored in the storage part 20 from the fuel cell module 15 according to the first mode of the first fuel cell group 100, may be supplied to the second fuel cell group 200 through the resupply line 30. In this case, the resupply line 30 may be connected to the second fuel cell group 200 from the storage part 20. The exhaust gas b2, which is stored in the storage part 20 and has a relatively low hydrogen concentration, may be used as a hydrogen supply source for the fuel cell module 16 according to the second mode of the second fuel cell group 200. The air (a) may be discharged through a separate channel provided separately from the channels for the supply gas b1 and the exhaust gas b2, each containing hydrogen.

### Fifth Embodiment

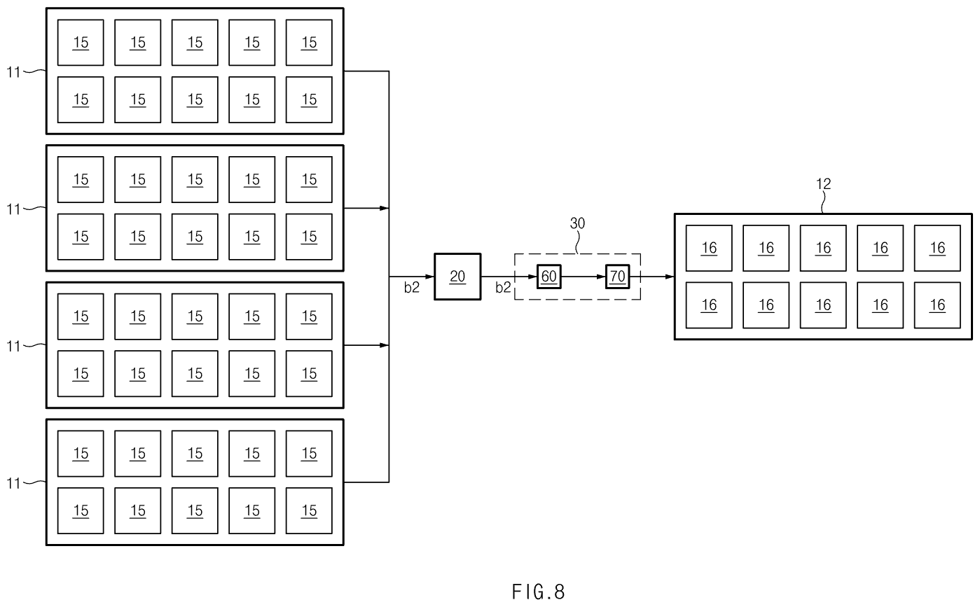

FIG. 8 is a structural view of an energy generation device according to a fifth embodiment of the present disclosure.

The fifth embodiment of the present disclosure may differ from the third embodiment in that a hydrogen concentration acquisition unit 60 and a flow rate control unit 70 are additionally provided in the resupply line 30.

Likewise, it is noted that the description of the energy generation device according to the third embodiment of the present disclosure may also be applied in common to the fifth embodiment, except for the difference. The fifth embodiment is described, focusing on the difference from the third embodiment.

With reference to FIG. 8, the energy generation device according to the fifth embodiment of the present disclosure may further include the hydrogen concentration acquisition unit 60. The hydrogen concentration acquisition unit 60 may be configured to sense a hydrogen concentration of the exhaust gas b2 flowing from the storage part 20 toward the second fuel cell pack 12. The hydrogen concentration acquisition unit 60 may be connected to the resupply line 30.

The energy generation device according to the fifth embodiment of the present disclosure may further include the flow rate control unit 70. The flow rate control unit 70 may be configured to control a flow rate of the flowing exhaust gas b2. Likewise, the flow rate control unit 70 may be connected to the resupply line 30 and disposed rearward of the hydrogen concentration acquisition unit 60 based on a flow direction of the exhaust gas.

The flow rate of the exhaust gas b2 may be controlled by the flow rate control unit 70 on the basis of the hydrogen concentration of the exhaust gas b2 sensed by the hydrogen concentration acquisition unit 60. For example, when the hydrogen concentration of the exhaust gas b2 sensed by the hydrogen concentration acquisition unit 60 decreases, the flow rate control unit 70 may appropriately maintain a total amount of hydrogen to be supplied to the second fuel cell pack 12 by increasing the flow rate of the exhaust gas b2. For example, the flow rate control unit 70 may be a mass flow controller (MFC) configured to control a flow rate by changing an opening degree of a valve.

### Sixth Embodiment

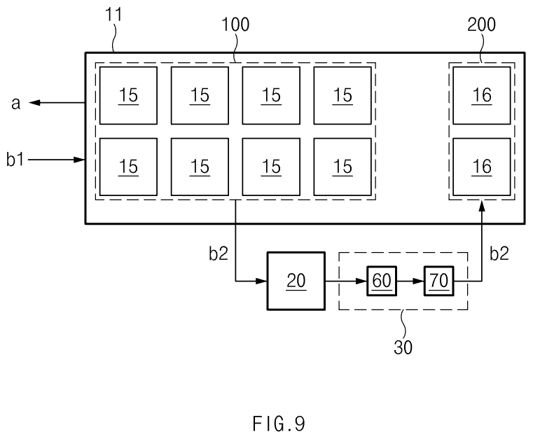

FIG. 9 is a structural view of an energy generation device according to a sixth embodiment of the present disclosure.

The sixth embodiment of the present disclosure may differ from the fourth embodiment in that the hydrogen concentration acquisition unit 60 and the flow rate control unit 70 are additionally provided in the resupply line 30.

Likewise, it is noted that the description of the energy generation device according to the fourth embodiment of the present disclosure may also be applied in common to the sixth embodiment, except for the difference. The sixth embodiment is described, focusing on the difference from the fourth embodiment.

With reference to FIG. 9, the energy generation device according to the sixth embodiment of the present disclosure may further include the hydrogen concentration acquisition unit 60. The hydrogen concentration acquisition unit 60 may be configured to sense a hydrogen concentration of the exhaust gas b2 flowing from the storage part 20 toward the second fuel cell group 200. The hydrogen concentration acquisition unit 60 may be connected to the resupply line 30.

The energy generation device according to the sixth embodiment of the present disclosure may further include the flow rate control unit 70. The flow rate control unit 70 may be configured to control the flow rate of the flowing exhaust gas b2. Likewise, the flow rate control unit 70 may be connected to the resupply line 30, provided in the flow route of the exhaust gas b2, and disposed rearward of the hydrogen concentration acquisition unit 60.

The flow rate of the exhaust gas b2 may be controlled by the flow rate control unit 70 on the basis of the hydrogen concentration of the exhaust gas b2 sensed by the hydrogen concentration acquisition unit 60. For example, in case that the hydrogen concentration of the exhaust gas b2 sensed by the hydrogen concentration acquisition unit 60 decreases, the flow rate control unit 70 may appropriately maintain a total amount of hydrogen to be supplied to the second fuel cell group 200 by increasing the flow rate of the exhaust gas b2.

While the present disclosure has been described above with reference to the limited exemplary embodiments and the drawings, the above description is simply given for illustratively describing the technical spirit of the present disclosure, and those skilled in the art to which the present disclosure pertains will appreciate that various changes and modifications are possible without departing from the essential characteristic of the present disclosure.

Therefore, the embodiments disclosed in the present disclosure are provided for illustrative purposes only but not intended to limit the technical spirit of the present disclosure. The scope of the technical spirit of the present disclosure is not limited thereby. The protective scope of the present disclosure should be construed based on the following claims, and all the technical spirit in the equivalent scope thereto should be construed as falling within the scope of the present disclosure.

### DESCRIPTION OF REFERENCE NUMERALS

11: First fuel cell pack
12: Second fuel cell pack
15: Fuel cell module according to the first mode
16: Fuel cell module according to the second mode
20: Storage part
30: Resupply line
40: Purification part
50: Supply line
60: Hydrogen concentration acquisition unit
70: Flow rate control unit
100: First fuel cell group
200: Second fuel cell group

What is claimed is:

1. An energy generation device comprising:
a first fuel cell pack including a plurality of fuel cell modules configured to use hydrogen as fuel;
a storage part configured to store exhaust gas discharged from the first fuel cell pack and containing hydrogen; and
a resupply line connected to the storage part and configured to supply the exhaust gas from the storage part to the first fuel cell pack or an external fuel cell pack.

2. The energy generation device of claim 1, wherein each fuel cell module of the plurality of fuel cell modules is configured to operate in a first mode in which hydrogen recirculates from a hydrogen electrode outlet of a fuel cell toward a hydrogen electrode inlet of the fuel cell.

3. The energy generation device of claim 1, further comprising:
a supply line configured to supply outside hydrogen to the first fuel cell pack,
wherein the resupply line communicates with the supply line.

4. The energy generation device of claim 3, further comprising:
a purification part provided in the resupply line and configured to receive the exhaust gas from the storage part and purify the hydrogen contained in the exhaust gas.

5. The energy generation device of claim 1, further comprising:
a second fuel cell pack including a plurality of fuel cell modules and provided outside the first fuel cell pack,
wherein the resupply line connects the second fuel cell pack and the storage part and is configured to supply the exhaust gas to the second fuel cell pack.

6. The energy generation device of claim 5, wherein the first fuel cell pack is provided as a plurality of first fuel cell packs.

7. The energy generation device of claim 5, wherein each fuel cell module of the plurality of fuel cell modules provided in the second fuel cell pack is configured to operate in a second mode in which hydrogen is discharged from a fuel cell without recirculating hydrogen.

8. The energy generation device of claim 5, further comprising:
a purification part provided in the resupply line and configured to receive the exhaust gas from the storage part and purify hydrogen contained in the exhaust gas,
wherein each fuel cell module of the plurality of fuel cell modules provided in the second fuel cell pack is configured to operate in a first mode in which hydrogen recirculates from a hydrogen electrode outlet of a fuel cell toward a hydrogen electrode inlet of the fuel cell.

9. The energy generation device of claim 1, wherein the first fuel cell pack comprises:
a first fuel cell group comprising a plurality of fuel cell modules that operates in a first mode in which hydrogen recirculates from a hydrogen electrode outlet of a fuel cell toward a hydrogen electrode inlet of the fuel cell; and
a second fuel cell group comprising a plurality of fuel cell modules that operates in a second mode in which hydrogen is discharged from the fuel cell without recirculating hydrogen.

10. The energy generation device of claim 9, wherein the storage part is configured to store exhaust gas discharged from the first fuel cell group, and the resupply line connects the second fuel cell group to the storage part and is configured to supply the exhaust gas from the storage part to the second fuel cell group.

11. The energy generation device of claim 9, wherein an amount of hydrogen per time supplied to the first fuel cell group is greater than an amount of hydrogen per time supplied to the second fuel cell group.

12. The energy generation device of claim 7, further comprising:
a hydrogen concentration acquisition unit connected to the resupply line and configured to sense a hydrogen concentration of exhaust gas flowing from the storage part toward the second fuel cell pack.

13. The energy generation device of claim 12, further comprising:
a flow rate control unit coupled to the resupply line between the hydrogen concentration acquisition unit and the second fuel cell pack and configured to control a flow rate of the exhaust gas.
